(19) United States
(12) Patent Application Publication
(10) Pub. No.: US 2025/0200447 A1
(43) Pub. Date: Jun. 19, 2025

(54) METHODS AND APPARATUS FOR TRUSTED OUTCOMES IN A CONSENSUS-BASED NETWORK OF AI MODELS

(71) Applicant: CharliAI Inc., Vancouver (CA)

(72) Inventors: Kevin COLLINS, Maple Ridge (CA); Elham ALIPOUR KHAYER, North Vancouver (CA); Joel EMERY, Coquitlam (CA)

(73) Assignee: CharliAI Inc., Vancouver (CA)

(21) Appl. No.: 18/983,708

(22) Filed: Dec. 17, 2024

Related U.S. Application Data
(60) Provisional application No. 63/612,072, filed on Dec. 19, 2023.

(51) Int. Cl. G06N 20/20

(52) U.S. Cl. CPC G06N 20/20

(57) ABSTRACT

There is disclosed a method and apparatus for generating desired trusted outcomes in a consensus-based network having a plurality of decision-focused computational models and an orchestration engine configured to organize the operation of these models. The orchestration engine is configured to receive requests from requestors and to generate input information related to these requests. The orchestration engine includes at least one decider model, which comprises an invoke module and an aggregation module. The invoke module forwards the input information to the decision-focused computational models, and the aggregation module receives and aggregates the singular outcomes to produce the desired trusted outcome. The decider model then communicates this outcome to the requestor.

### CROSS REFERENCE TO RELATED APPLICATION

This application claims priority to and the benefit of U.S. Provisional Application No. 63/612,072, entitled “METHODS AND APPARATUS FOR TRUSTED OUTCOMES IN A CONSENSUS-BASED NETWORK OF AI MODELS” and filed Dec. 19, 2023, which is hereby incorporated by reference in its entirety for all purposes.

### FIELD OF THE DISCLOSURE

The present disclosure relates to a consensus-based network of decision-focused computational models and, more particularly, to providing trusted outcomes in the consensus-based network.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Computational models, including artificial intelligence (AI) models are commonly deployed in cloud-based decentralized, distributed networks or hybrid networks. These networks are systems where computing resources and data are distributed across multiple nodes or servers, typically hosted in the cloud. These networks leverage the advantages of both decentralization and cloud computing to enable scalable, resilient, and flexible computational infrastructures. However, despite their benefits, these networks often face challenges related to trust in the outcomes they produce. One significant issue with trust in cloud-based decentralized networks is the lack of transparency in decision-making processes. With multiple nodes participating in computations or data processing, it can be challenging to understand how a particular outcome was reached or to verify the correctness of the results. This lack of transparency can erode trust as participants may have concerns about the fairness, accuracy, or integrity of the network's outcomes. By addressing trust challenges, cloud-based decentralized or distributed networks can enhance their reputation, increase participant confidence, and realize their full potential in providing scalable, resilient, and trustworthy computational infrastructures for a wide range of applications.

### BRIEF SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

The present disclosure relates to a consensus-based network of decision-focused computational models and, more particularly, to providing trusted outcomes in the consensus-based network.

In one aspect, there is provided a method for generating trusted outcomes in a consensus-based network. The network has a plurality of decision-focused computational models, and a decider model communicatively coupled to the plurality of decision-focused computational models. The method comprises: the decider model receiving a request from a requestor; the decider model forwarding input information corresponding to the request to the plurality of decision-focused computational models; the plurality of decision-focused computational models responsive to the input information being invoked to generate singular outcomes based on the input information, one singular outcome for each invoked decision-focused computational model, and communicating the singular outcomes to the decider model; the decider model aggregating the singular outcomes to generate a desired trusted outcome response; and the decider model communicating to the desired trusted outcome response to the requestor.

In another aspect, there is provided a consensus-based network for generating desired trusted outcomes comprising a plurality of decision-focused computational models configured to process input information and generate singular outcomes, one for each computational model. The network further comprises an orchestration engine communicatively coupled to and organizing operation of the plurality of decision-focused computational models. The orchestration engine is configured to receive requests from requestors and generate the input information related to the requests. The orchestration engine comprises at least one decider model. The at least one decider model comprises an invoke module and an aggregation module. The invoke module is configured to forward the input information to the plurality of decision-focused computational models and the aggregation module is configured to receive and aggregate the singular outcomes to produce the desired trusted outcome. In the network the at least one decider module is configured to communicate the desired trusted outcome response to the requestor from the orchestration engine.

In another aspect, there is provided a computer implemented method for generating desired trusted outcomes in a consensus-based network having a plurality of decision-focused computational models, a plurality of decider models communicatively coupled to the plurality of decision-focused computational models and at least one interaction hub communicatively coupled to the decider models. The method comprises organizing the decision-focused computational models in a matrix fashion by model scope and model class, wherein the decision-focused computational models that are trained with the same or similar training data information are grouped by model scope, and further grouping the decision-focused computational models having the same model scope into different model classes, each determined by algorithmic families. The method further comprises associating at least one of the decider models with each of the decision-focused computational models grouped in a model class, wherein input information is sent to the decision-focused computational models grouped within that model class by the associated decider model, and wherein the decision-focused computational models grouped in that model class have different model scopes. In the method, a requestor communicates a request to one or more of the associated decider models through an interaction hub and the one or more associated decider models forwards the input information corresponding to the request. The method further comprises each of the decision-focused computational models discerning from the input information if it is able to be invoked and each of the decision-focused computational models sending an acceptance message to the one or more associated decider models when invoked. In the method, the plurality of decision-focused computational models responsive to the input information being invoked generating singular outcomes, one for each invoked decision-focused computational model, and communicating the singular outcomes to the associated decider model. The associated decider model aggregating the singular outcomes to generate the desired trusted outcome response and the associated decider model communicating to the requestor via the interaction hub the desired trusted outcome response.

The term “requestor” as used herein refers to any entity that initiates a request to the consensus-based network either directly or via the interaction hub. The requestor may be a human user interacting through a client portal, which is a user-friendly interface within the interaction hub, or the requestor may be a computational system, such as, for example, a system agent, engaging in system-to-system interactions.

The term “interaction hub” refers to the aspect of a central platform that facilitates bidirectional communication and data exchange between various entities within a consensus-based network. It serves as the medium through which requests are initiated, and responses are received, supporting both human users and system-to-system interactions. The interaction hub may include a client portal, which provides a user-friendly interface for human users to submit their requests and receive responses. Additionally, it may enable seamless integration and interoperability between different computational systems, such as, for example, system agents, allowing for automated, real-time, and scalable data processing and decision-making without direct human intervention.

In an embodiment, the consensus-based network further comprises at least one hierarchal decider model communicatively coupled between the associated decider models and the interaction hub and the hierarchal decider model receiving the request, invoking the associated decider models, aggregating the desired trusted outcome response from each of the associated decider models to generate the desired trusted outcomes and communicating to the requestor via the interaction hub the desired trusted outcomes.

In another aspect, there is a computer implemented method for generating desired trusted outcomes in a consensus-based network having a plurality of decision-focused computational models, with one or more decider models supporting the decision-focused computational models. In this aspect, each decision-focused set of computational models is intended to support an outcome that would comprise a set of outcomes in the case of a complex decision flow where multiple outcomes are desired.

In another aspect, there may be multiple groupings of decision-focused computational models supported by one or more decider models, and the groupings of computational and decider models may be further invoked, aggregated and managed by yet a separate decider model. This supports hierarchical and matrixed grouping of computational and decider models.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodi-ment thereof. To easily identify the discussion of any particular element or act, the most significant digit or digits in a reference number refer to the figure number in which that element is first introduced. Exemplary non-limiting embodiments are described with reference to the accompanying drawings in which:

FIG. 1 illustrates an aspect of the subject matter in accordance with one embodiment of an operational network of AI models that operate in a consensus-based network.

FIG. 2 illustrates an aspect of the subject matter in accordance with one embodiment of decider model operation within the consensus-based network.

FIG. 3 illustrates an aspect of the subject matter in accordance with one embodiment of decider model operation within the consensus-based network where AI models are grouped in computational model classes and computational model scopes within the consensus-based network.

FIG. 4 illustrates a routine 400 for generating desired trusted outcomes in a consensus-based network having a plurality of decision-focused computational models, at a decider model communicatively coupled to the plurality of decision-focused computational models in accordance with one embodiment.

FIG. 5 illustrates a routine 500 for generating desired trusted outcomes in a consensus-based network having a plurality of decision-focused computational models, a plurality of decider models communicatively coupled to the plurality of decision-focused computational models and at least one interaction hub communicatively coupled to the decider models in accordance with one embodiment.

FIG. 6 illustrates a routine 600 for generating desired trusted outcomes in a consensus-based network having a plurality of decision-focused computational models, a plurality of decider models communicatively coupled to the plurality of decision-focused computational models and at least one hierarchal decider model communicatively coupled to the decider models in accordance with one embodiment.

### DETAILED DESCRIPTION

The aspects described herein relate to a consensus-based network of decision-focused computational models, including artificial intelligence (AI) models, and, more particularly, to method and apparatus for providing trusted outcomes in the consensus-based network and for providing scalability in the consensus-based network.

The present disclosure relates to a method and apparatus for establishing trust in a consensus-based network of decision-focused computational model outcomes, whereby outcomes are the result of consensus among multiple collaborative or competing decision-focused computational models. The term “decision-focused computational model” refers to a specialized type of computational model within the consensus-based network that is designed to support decision-making processes. These models are integral components of the network, operating to process input information and generate singular outcomes based on the input data. In an embodiment, the decision-focused computational models comprise AI models. It should be understood that when referring to AI models in the present disclosure, this reference encompasses various decision-focused computational model types such as, for example, Machine Learning Models, Deep Learning Models, or Rule-Based Models for intelligent processing. The decision-focused computational models should not be restricted or constrained and may depend on a specific implementation, allowing for flexibility in the choice of models for the intended purpose.

In an embodiment, the consensus-based network includes multiple AI models that operate within the consensus-based network and that operate across similar data inputs to collaborate on the generation of an outcome. In such a network, each AI model independently processes input data and generates its own prediction or decision. These individual outputs may differ due to variations in model architectures, training data, or other factors. The multiple AI models operate to produce the desired or best outcome given a diversity of possible input information made available to the AI models. Within the consensus-based network of AI models, individual models process the input and generate a singular output. This singular output is consolidated with all other singular outputs from operating AI models within the consensus-based network. The consolidated model outcomes may then be evaluated to produce a desired outcome.

The term “consensus” in the context of a consensus-based network of AI models in the present disclosure refers to the process by which multiple AI models within the network collaborate to reach an agreement on a prediction, decision, or output. The goal is to achieve a more accurate, robust, and reliable output compared to that of any individual model in isolation. It should be understood that the use of multiple AI models, each of which may be trained on foundational algorithms to perform specific tasks, may collaborate or operate in ensembles with other AI models in the consensus-based network to provide AI agents that provide more advanced systems that may utilize the AI models to perform tasks autonomously. Further AI agents may also work together to achieve Agentic workflows, or Agentic flows, to perform more complex tasks. These workflows may be iterative and adaptive, allowing AI agents to plan, execute, and refine their actions based on feedback and changing circumstances or outcomes. The AI models are the building blocks, the AI agents are the autonomous systems built from these blocks, and agentic workflows are the sophisticated processes that enable these agents to work together effectively. Hence, reference to singular outcomes from decision-focused computational models may comprise outcomes from AI models, AI Agents and Agentic workflows.

In an embodiment, the present disclosure relates to a method for generating desired trusted outcomes in a consensus-based network comprising a plurality of decision-focused computational models and a decider model communicatively coupled to the plurality of decision-focused computational models. The disclosure sets out steps in the method to ensure the generation of trusted outcomes.

In one embodiment, the method includes the decider model receiving a request from a requestor. The decider model then forwards input information corresponding to the request to the plurality of decision-focused computational models. Each of these computational models, upon receiving the input information, is invoked to generate singular outcomes based on the input information. Each invoked decision-focused computational model generates one singular outcome and communicates this outcome back to the decider model. The decider model aggregates these singular outcomes to generate the desired trusted outcome response, which is then communicated back to the requestor.

In another embodiment, each of the decision-focused computational models discerns from the input information whether it is able to be invoked. Upon determining its capability to process the input information, each decision-focused computational model sends an acceptance message to the decider model when invoked.

In a further embodiment, the decider model selectively forwards input information to selected decision-focused computational models based on the relevance and capability of each model to process the input information. The decider model determines the suitability of each decision-focused computational model to handle the input information before forwarding it.

Additionally, in another embodiment the method includes organizing the decision-focused computational models in a matrix fashion by model scope and model class. The decision-focused computational models trained with the same or similar training data information are grouped by model scope. Further, the decision-focused computational models having the same model scope are grouped into different model classes, each determined by algorithmic families.

In another embodiment, the method comprises associating at least one decider model with each of the model classes for selecting and/or merging the singular outcomes of decision-focused computational models of the same model class to generate same class desired trusted outcomes. At least one desired trusted outcome is generated for each of the model classes. Additionally, at least one hierarchical decider model is communicatively coupled to manage invoking the decider models associated with each model class and to aggregate the generated same class desired trusted outcomes. This supports hierarchical and matrixed groupings of the decision-focused computational models and the decider models.

In another embodiment, the method includes coordinating the decision-focused computational models and the decider models by an orchestration engine that includes a management layer. The management layer includes the hierarchical decider model. The orchestration engine is governed by a monitoring and management system providing AI governance over the execution of the orchestration engine and the hierarchical decider model, thereby ensuring the viability and integrity of execution and outcomes.

In another embodiment, the method involves assigning, via the decider model, a confidence score to each of the singular outcomes generated by the decision-focused computational models. Each confidence score is indicative of the reliability and accuracy of the respective singular outcome. The decider model aggregates the singular outcomes based on their respective confidence scores to produce the desired trusted outcome response, wherein outcomes with higher confidence scores exert a greater influence on the final trusted outcome response.

In another aspect, the present disclosure relates to a consensus-based network for generating desired trusted outcomes. This network comprises a plurality of decision-focused computational models and an orchestration engine configured to organize the operation of these models. The orchestration engine is configured to receive requests from requestors and to generate input information related to these requests. It includes at least one decider model, which comprises an invoke module and an aggregation module. The invoke module forwards the input information to the decision-focused computational models, and the aggregation module receives and aggregates the singular outcomes to produce the desired trusted outcome. The decider model then communicates this outcome to the requestor.

In one embodiment of the network, each decision-focused computational model is configured to discern from the input information whether it can be invoked. Upon determining its capability to process the input information, the computational model sends an acceptance message to the decider model when invoked.

In another embodiment of the network, the decider model is configured to selectively forwards the input information to selected decision-focused computational models based on the relevance and capability of each model to process the input information. The decider model determines the suitability of each computational model before forwarding the input information.

In another embodiment of the network, the orchestration engine is configured to organize the decision-focused computational models into a multidimensional matrix based on model classes and model scopes. Each model class is defined by the implementation of an algorithm families, and each model scope is defined by its training data information. The orchestration engine is configured to organizes each computational model by one of the model classes and one of the model scopes.

In another embodiment of the network, one decider model is associated with each model class to communicate the input information to the decision-focused computational models grouped in that class and to receive and aggregate the singular outcomes to generate a same class desired outcome. The orchestration engine further comprises at least one hierarchical decider model that manages invoking the associated decider models for each model class and aggregates the generated same class desired trusted outcomes.

In another embodiment of the network, the orchestration engine comprises a management layer that comprises the hierarchical decider model.

In another embodiment of the network, the network further comprises a monitoring and management system configured to provide AI governance over the execution of the orchestration engine and the hierarchical decider model, ensuring the viability and integrity of execution and outcomes.

In yet another embodiment of the network, the decider model is configured to assign a confidence score to each singular outcome generated by the decision-focused computational models. Each confidence score indicates the reliability and accuracy of the respective singular outcome. The decider model is further configured to aggregate the singular outcomes based on their respective confidence scores to produce the desired trusted outcome response, with higher confidence scores exerting a greater influence on the final trusted outcome response.

Additionally, in another embodiment of the consensus-based network, the orchestration engine may be configured to support loose coupling of the decision-focused computational models, allowing models to be added or removed from the network as needed, thereby enhancing scalability and resilience.

In another embodiment, the network further comprises at least one challenger model communicatively coupled to the decision-focused computational models and the decider model. The challenger model is configured to validate the outcomes generated by the decision-focused computational models and/or the decider model by applying AI model methods to cross-reference checks, relevancy checks, and/or privacy checks, ensuring the trustworthiness and integrity of the outcomes within the consensus-based network.

This approach ensures that the consensus-based network may handle intricate decision-making processes by leveraging the collective capabilities of multiple decision-focused computational models, thereby enhancing the accuracy, reliability, and trustworthiness of the generated outcomes.

In an embodiment, the consensus-based network may comprise multiple groupings of decision-focused computational models, each supported by one or more decider models. These groupings may be further invoked, aggregated, and managed by an additional, separate decider model. This hierarchical and matrixed structure allows for a more organized and efficient processing of complex decision flows. Specifically, each grouping of decision-focused computational models may be tailored to address specific tasks or domains, with their respective decider models overseeing the invocation and aggregation of outcomes within those groupings. The separate decider model at a higher level may then manage and aggregate the outcomes from these groupings, ensuring a cohesive and comprehensive decision-making process. This hierarchical and matrixed approach enhances the scalability, flexibility, and robustness of the consensus-based network, enabling it to handle a wide range of applications and complex decision-making scenarios.

The present disclosure describes a method whereby evaluation of the consolidated model outcomes is based on a Decision Model or Decider Model configured to select and/or merge singular outcomes to generate a desired trusted outcome. The Decider Model may comprise one or more AI models, or any other suitable decision-focused computational models or combinations thereof.

In one aspect there is provided a consensus-based network where AI models operating within the network are invoked to operate on similar data and provide singular outcomes that are operated on by the decider model. According to an aspect, the consensus-based network may include a comprehensive and structured method of classification and labeling of AI models. In embodiments, this classification and labeling may be extended to meet additional requirements. Further a multi-dimensional method of classification and labeling may be provided whereby the consensus-based network of AI models operates effectively across multiple use cases.

In an embodiment, the multi-dimensional method of classification and labeling may include domain scopes, model classes, model types, and model scores.

The domain scopes refer to the breadth or scope of AI model training and execution such as, for example, global or more restrictive training within sub-scopes.

The model classes refer to a logical grouping of models that operate on commonly associated inputs.

The model types refer to general type definitions of models such as, for example, specific algorithms or techniques used within a model class.

The model scores refer to a method of scoring models on outcomes.

In an aspect, the multi-dimensional classification method is not restrictive in nature to the scopes, types, and classes, and is readily extended as new classification dimensions are identified.

In an aspect, there is provided a method for conveying trust in the training and execution of AI models within the consensus-based network. Several elements may be involved in the conveyance of trust in the consensus-based network which may include classification and labeling associated with data governance and security policies. It is contemplated that a structured technical definition is associated to all models that operate in the consensus-based network. In an embodiment, the technical definition includes classifications, labels, and policy definitions providing a common understanding of the models within the consensus-based network.

The inputs to AI models within the consensus-based network, either for training or execution, may include data in the form of one or more entities (i.e., entities_{1 . . . n}). One of ordinary skill in the art will appreciate that the entities may be simple values or more complex data structures.

One of ordinary skill in the art will appreciate that the AI models may generally, but not always, operate in ensembles and be orchestrated.

### Model Network and Orchestration

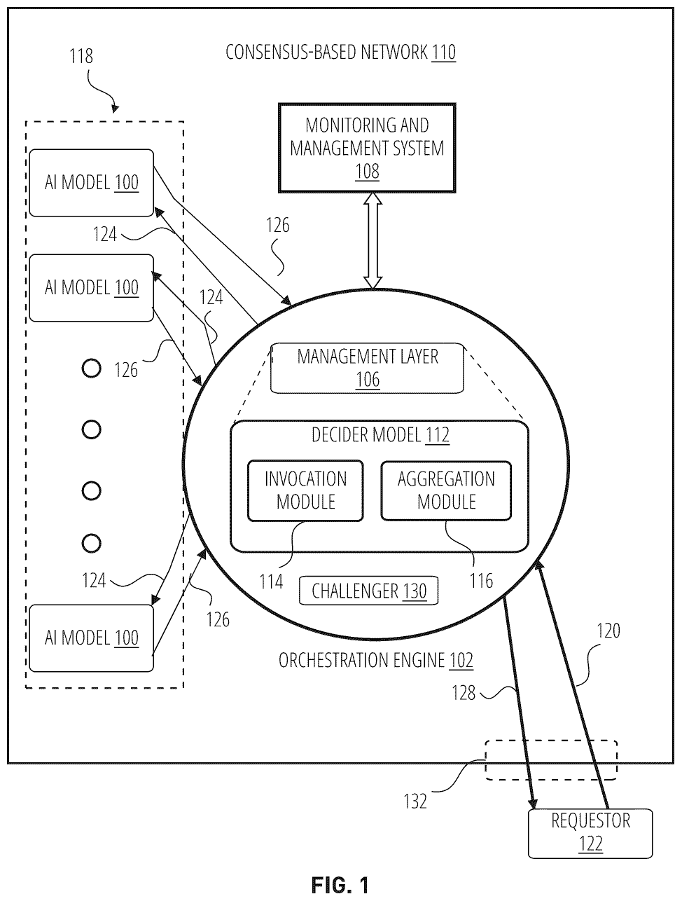

FIG. 1 illustrates an aspect of the subject matter in accordance with one embodiment of a consensus-based network 110. The network 110 includes several AI models 100 that are illustratively shown as being part of a series or plurality of decision-focused computational models 118. AI models 100 operate independently within the consensus-based network 110 and are coordinated, that is, orchestrated, via orchestration engine 102. Orchestration engine 102 includes a management layer 106. Management layer 106 is configured to invoke AI models 100 (Invocation) as well as aggregate outcomes from AI models 100 (Aggregation) in the consensus-based network 110. The components within the management layer 106 for Invocation and Aggregation may differ and may include rule-processing, logic processing, AI models and/or other computational components.

In one embodiment, the management layer 106 includes a decider model 112 for receiving requests 120 from one or more requestors 122. An Invocation component or module 114 is illustrated as an instance of a decider model 112. Invocation module 114 decides how and when to invoke AI models 100 in the consensus-based network 110. Invocation refers to the action of calling or activating AI Model 100 triggering the execution of AI models for processing input data 124 sent from the decider model 112 and generating predictions or decisions. In the present disclosure the invocation process comprises passing the input data 124 related to the requests 120 to the AI models, acceptance of the input data by one or more of the AI models and initiating computations or inference procedures by the AI model 100 that accept the input data.

An Aggregation component or module 116 is illustrated as an instance of a decider model 112 provides an aggregation process for aggregating Outcomes 126 from AI models 100 in the consensus-based network 110. The aggregation of outcomes 126 occurs by combining or merging the individual outputs or predictions 126 produced by one or more invoked AI models 100 into a single consolidated outcome response 128 that is returned to the requestor 122. The aggregation step aims to arrive at a unified decision or prediction that represents the collective perspective or agreement of the invoked AI models within the consensus-based network 110.

It should be understood that the decider model 112 and its components or modules 114, 116 for the invocation and aggregation tasks may differ. For example, these components may include rule-processing systems, logic processing mechanisms, other computational components, or additional AI models that aid in the invocation and aggregation processes. These components work together to effectively call the AI models 100, collect their individual outputs, and determine the overall outcome for the consensus-based network 110.

In an alternative embodiment to that shown in FIG. 1, the decider model 112 of the management layer 106 may operate directly with the AI models 100 when used in consensus-based networks 110 whereby an orchestration engine is not employed.

In an embodiment, the consensus-based network 110 may communicate with the requestor 122 via an interaction hub 132 (shown in FIG. 1 in broken lines). The interaction hub 132 facilitates bidirectional communication and data exchange between various entities within a consensus-based network. It serves as the medium through which requests are initiated, and responses are received, supporting both human users and system-to-system interactions. The interaction hub may include a client portal, which provides a user-friendly interface for human users to submit their requests and receive responses. Additionally, it may enable seamless integration and interoperability between different computational systems, such as, for example, system agents, allowing for automated, real-time, and scalable data processing and decision-making without direct human intervention.

In FIG. 1 the orchestration engine 102 communicates with a monitoring and management system 108. The monitoring and management system 108 ensures all components of the consensus-based network 110 are working as intended. The monitoring and management system 108 may further facilitate efficient troubleshooting and problem resolution as well as oversee the operational efficiency and functionality of the consensus-based network 110. The monitoring and management system 108 provides AI Governance over the execution of the orchestration engine 102 and the decider model 112 to ensure viability and integrity of the execution and outcomes. The monitoring and management system 108 may also incorporate intelligent processing in the form of rules-based or machine-learning processes to intelligently manage and govern the orchestration and decider models 112. An example of monitoring and management includes recording and verification that outcomes fall within expected tolerances.

The orchestration engine 102 provides smooth execution, synchronization, and collaboration among the various AI models 100, including computational models, or components and resources involved in the consensus-based network 110. The orchestration engine 102 handles the overall workflow and coordination of tasks within the consensus-based network 110. It manages the allocation and utilization of resources, schedules the execution of AI models 100, and facilitates communication and data flow between different components in the consensus-based network 110 through a high-performance algorithm.

In FIG. 1 loose coupling of AI models 100 in the consensus-based network 110 may be governed by a set of multi-dimensional classifications (i.e., technical specifications and policies). The loose coupling of the AI models 100 readily allows AI models to be added or removed from the consensus-based network 110.

In an embodiment, all models within the consensus-based network 110 are governed according to the multi-dimensional classifications including training of the AI models and operation of the AI models.

### Model Scopes

The AI models 100 in the consensus-based network 110 have model scopes which may be collectively referred to as computational model scopes. The model scopes provide a first-level element in the trust of AI model outcomes and provide a definition of the scope or domain for each AI model 100 that operates in the network of computational models 118. The model scope may be defined by describing in detail model inputs, model outputs, model behavior, model classification, model role, model policy, and model governance. In an embodiment, the model scopes define how AI models 100 are trained, how AI models 100 are executed, and the fine-grained data queries with which AI models 100 may be provided with training data (training) or data input (execution).

### Model Classes

In an aspect, the AI models 100 may be grouped into model classes that identify AI models 100 that operate in a similar domain and provide outcomes that may be aggregated within that domain. In an embodiment, class definitions are used to ensure that like-kind models are readily applied across a specific use case or set of use cases. For example, in one embodiment, various models may be classed as OCR and provide OCR services. These OCR models may therefore operate in specific cases within an orchestration. In another embodiment example, a set of models may be classed as Entity Extractors that operate on similar input entities; and therefore, these models may be invoked by a Decider model 112 to satisfy the outcome requirements.

### Model Types

In an aspect, the AI models 100 may include model types provided in multi-dimensional classifications to identify the type of model or algorithm applied to generate an outcome. This form of model type definition provides useful metadata for Decider models 112 to operate the consensus-based network 110 both for Invocation and Aggregation.

### Model Scores

Within an AI system or a system of intelligence, one of ordinary skill in the art will appreciate there are dependencies on computational methods performed by, for example, AI models, machine learning models, rule-based processing models, and logic processing models to determine outcomes. For the purposes of the present disclosure, the processing performed by these models to produce an outcome is referred to as calculations. Calculations (i.e., processing of the data to achieve an outcome) includes scoring mechanisms. Scoring can be applied in two primary contexts: scoring the output which involves assessing the results produced by the model and scoring the model which involves evaluating the performance of the model itself using various benchmarking results. Example of scoring the outputs include confidence scores, relevancy scores, risk scores, utility scores, anomaly scores and LLM-driven scoring. Examples of scoring metrics for model evaluation include precision, recall, F1 score, MSE and others. The final score of a calculation may be a combination of scoring the output and the score of the model itself. One of ordinary skill in the art will appreciate that scoring is an integral element of model processing within an AI system or system of intelligence. For the purposes of scoring, it is assumed that multiple data points and methods will be applied in generating scores that can be consumed, aggregated, compared, contrasted and used within the AI system or system of intelligence. In an aspect, the scores from different data types (e.g. text. image, audio) may be combined to give a more comprehensive assessment (multi-modal scoring). In another aspect, multiple models may be utilized to generate scores, aggregating diverse perspective for more robust prediction (ensemble scoring). In another aspect, reinforcement learning techniques may be used to continuously refine scoring mechanism based on feedback and performance over time (adaptive scoring).

In an aspect there is provided a method for capturing scores related to generation of an outcome or outcomes. In an embodiment, the decider model 112 captures scores within the consensus-based network 110 of AI models 100. The decider model 112 determines the best outcome from the scores. The decider model 112 may further continually monitor the health of the models within the consensus-based network 110. Scores may identify the type and method of scoring. In this aspect the decider model 112 is a component in the overall management of the consensus-based network 110. In an embodiment, the decider model 112 assigns a confidence score to each singular outcome generated by the decision-focused computational models 118 or AI models 100, wherein the confidence score is indicative of the reliability and accuracy of the respective singular outcome. The decider model 112 further aggregates the singular outcomes 126 from the AI model 100 based on their respective confidence scores to produce the desired trusted outcome response 128, wherein outcomes 126 with higher confidence scores exert a greater influence on the final trusted outcome response 128.

### Decider Models

In the embodiment shown in FIG. 1, the decider model 112 is a component of the consensus-based network 110. In one embodiment of this disclosure, the decider model 112 of the consensus-based network 110 includes one or more decision AI models designed to manage the invocation of AI models 100 within the consensus-based network 110. In another embodiment of this disclosure, the decider model 112 includes one or more decision AI models designed to aggregate outcomes from the AI models 100 in the consensus-based network 110. In this aspect, the decider model 112 is utilized in the invocation and aggregation processes carried out within the consensus-based network 110.

In an embodiment, invocation of the AI models 100 in the consensus-based network 110 is based on decisions made according to the input entities and associated metadata, and multi-dimensional classification of the AI models 100. In this embodiment, the decider model 112 invoked one or more AI models 100 in the consensus-based network 110 and ensures policy enforcement according to the multi-dimensional classification.

Aggregation of outcomes from the AI models 100 in the consensus-based network 110 is an element for achieving accuracy and trust in the outcomes. The present disclosure proposes that for Aggregation decider models 112 will select and/or merge outcomes from the AI models 100 in the consensus-based network 110. Aggregation is in accordance with policies conveyed through the multi-dimensional classification (i.e., a set of technical specifications and policies).

### Challenger Models

In an aspect of the present disclosure, Challenger Models 130 are provided as a class of models designed to challenge the outcomes from one or more AI models 100 within the consensus-based network 110. Within the orchestration of the AI models 100, the challenger models 130 will apply AI model methods to validate the outcomes from either the network AI model 100 and/or the Decider Models 112. In one embodiment, the challenger models 130 validate outcomes from individual models in the network of AI models 100. In another embodiment, the challenger models 130 validate the outcome from the Decider Model(s) 112. In yet another embodiment, the challenger models 130 will perform validation as a tie breaker between model outcomes 126 as evaluated by the Decider Model(s) 112. In an embodiment, the challenger models 130 perform cross-reference checks on extracted entities and/or relevancy checks on generated statements and/or privacy checks on outcomes and/or other methods to verify and trust the outcome of AI models 100 within the network. Challenger models 130 will evolve independently and may be extended to provide various degrees of validation.

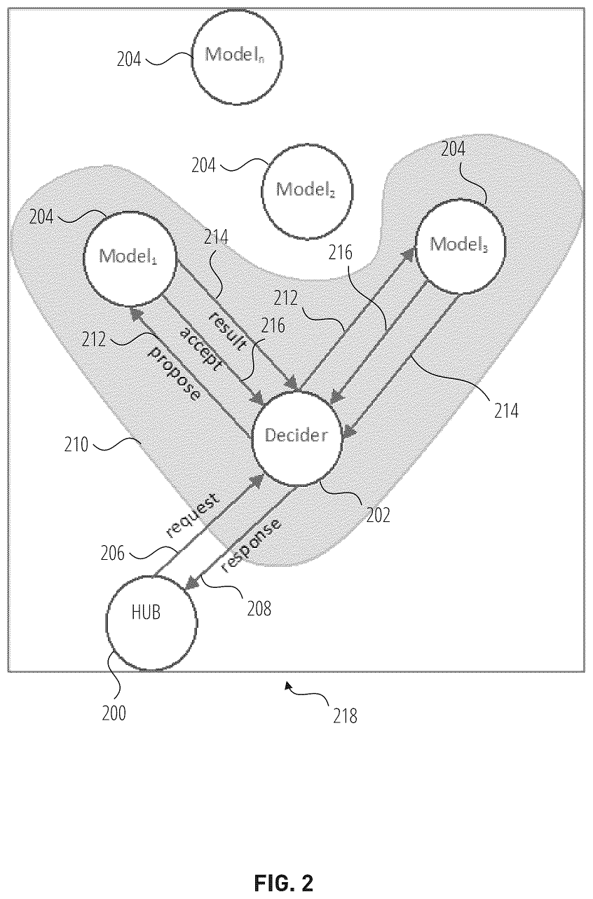

FIG. 2 generally illustrates an exemplary protocol in a consensus-based network 218 by which a decider model 202 invokes AI models 204 to operate further to a request from a requestor, and for the decider model 202 to return an aggregated or trusted outcome or response 208 to the client. The requestor may access the consensus-based network 218 via a client portal or interaction hub 200 that is communicatively coupled to the consensus-based network 218 for sending requests 206 and receiving trusted outcomes 208.

The interaction hub 200 may comprise one or more computers that may be accessed by one or more requestors to make various requests of the consensus-based network 218. These requests may include, but are not limited to:

1. Input of data: Requestors may input relevant data, such as, for example, numerical values, text descriptions, or multimedia files, for the consensus-based network 218 to analyze and process.

2. Decision inquiries: Requestors may seek decisions or recommendations from the consensus-based network 218 based on specific criteria or conditions provided. For example, a requestor may request the system to recommend suitable products based on their specific preferences and needs.

3. Predictive analysis: Requestors may request the consensus-based network 218 to provide predictive insights or forecasts based on historical data and patterns. This may aid in making informed decisions or planning future strategies.

4. Optimization queries: Requestors may ask the consensus-based network 218 to optimize certain parameters or achieve specific goals. This may involve finding the best solution among various possibilities or maximizing efficiency in resource allocation.

5. Comparative analysis: Requestors may request the consensus-based network 218 to compare different options or scenarios and provide insights or recommendations based on predefined criteria. This may assist in evaluating different strategies or alternatives.

6. Feedback and adaptability: Requestors may provide feedback to the consensus-based network 218 regarding the accuracy or relevance of its decisions, allowing the system to improve its predictive capabilities over time.

It should be understood that the above examples are non-limiting, and requestors may make a wide range of requests to the AI-based decision-making system via the hub 200, depending on the specific implementation and the capabilities of the system.

In FIG. 2, the requestor makes a request 206 via hub 200 to the decider model 202. For example, request 206 may comprise a single work request requiring natural language processing. The request 206 is published or sent by decider model 202 as an invoking proposal message 212 which includes the same or similar data sent to each of the multiple computational models or AI models 204 for determination of the intent and entities in a sentence provided in the request. It should be understood that in this example the intent refers to the purpose or goal behind a particular statement or request made in natural language, and entities refer to the specific pieces of information or objects mentioned in the sentence which may include, for example, people, locations, dates, or any other relevant entities that are being referred to in the text.

The AI models 204 that accept the proposal message 212 are shown in the shaded area 210 and the AI models 204 send an accept message 216 to the decider model 202 so that the decider model 202 is aware of which AI models 204 will be providing an outcome or result 214. The decider model 202 effectively invokes one or more AI models 204 that accept the proposal to perform calculations to determine intent and entities.

In FIG. 2, the AI models 204 accept the inbound request 206 from decider model 202 based on context, and the AI models 204 process the request in order to determine intent and entities. The result from the AI models 204 that works on the request is return as a singular outcome or result 214 to the decider model 202 for aggregation. The decider model 202 then determines a final result and returns the trusted outcome or response 208 to the hub 200. Thus, the consensus-based network 218 provides a level of assurance that more precisely determines the intent and entities through multiple levels of processing and completes that processing in parallel thereby improving precision and performance of the network 218.

It should be understood that in the request example, the classified intent may be improved through more fine-grained organizational training data and the determination of entities may be improved with industry training data.

The decider model 202 is the final deciding factor on what result to apply from the various AI models 204 that accept and respond to work requests 206. Within the consensus-based network 218, the decider model 202 is acting as a leader and proposer. The decider model 202 receives incoming work requests 206 and tracks these incoming work requests for processing. Tracking of the work request is part of the preparation stage for sending out similar data proposal messages 212 corresponding to the requests 206 to the AI models 204 for acceptance and processing by the AI models 204. The decider model 202 publishes the request 206 to the set of AI models 204 that make up a quorum that responds. One or more AI models 204 accept the request sent via the proposal message 212. Once outcomes or results 214 are received from the AI models 204, the decider model 202 aggregates in its aggregation module 116 these results and decides the final result to apply and pass back to the originating client application as the desired trusted outcome response 208. The requestor receives a trusted outcome 208 through the hub 200.

The trusted outcome 208 may be delivered to requestors through the interaction hub 200 in various ways. For example, the system may generate notifications or alerts to inform requestors about a trusted 7outcome response 208. These may be displayed as pop-ups, messages, or badges on a display for the hub 200. Requestors may click on the notification to view more details or take appropriate actions. In another example, the hub 200 may include interactive dashboards where outcomes are visualized in the form of charts, graphs, or tables. Requestors may navigate through different sections of the dashboard to access and analyze the outcomes relevant to their workflow. In another example, the system may generate summarized reports or insights that provide a comprehensive overview of the outcomes. These reports may be presented within the hub 200 allowing requestors to review and analyze the information at their convenience. In another example, through a dedicated section or panel of the hub 200, the system may present recommendations or suggestions based on outcomes. These panels may provide actionable insights or prompt requestors to consider specific improvements in their workflow. In yet another example for the outcomes may be made available to a requestor via the hub 200 to visualize outcomes through interactive data visualizations, such as, for example, charts, graphs, or heatmaps. Requestors may interact with these visualizations to explore and interpret the outcomes in a more intuitive and contextual manner. The hub 200 may provide outcomes directly within the hub 200 by utilizing pop-up messages or tooltips. These serve as contextual hints or suggestions related to specific elements or actions in the interface. Workflow insights/widgets may be included in the hub 200 that display predicted outputs specific to the workflow. For instance, a widget may show predicted time estimations, resource allocations, or risk assessments, providing requestors with immediate visibility into key predicted outcomes. The outcomes may include personalized notifications delivered to individual requestors through personalized notifications on the hub 200. These notifications may be tailored to their roles, preferences, or areas of responsibility within the workflow. The method of delivering outcomes to requestors ultimately depend on the design and functionality of the hub 200. The goal is to present the information of outcomes in a clear, accessible, and actionable manner. The hub 200 elements should be designed to accommodate different types of outcomes effectively while promoting requestor understanding and engagement.

It should be understood that the use of an Interaction hub is optional and there are other embodiments where the consensus-based network of AI models may be applied in more of a system-to-system interaction where human interaction is not directly supported.

System-to-system interactions refer to the communication and data exchange between different computational systems or software applications without direct human intervention. In the context of the consensus-based network of AI models, this entails that the AI models may interact with each other and with other systems to autonomously process data, make decisions, and generate outcomes. Aspects of system-to-system interactions may include automated data exchange systems that automatically transmit and receive data from each other. For example, one system may collect data from sensors or databases and transmit it to the AI models for analysis. System-to-system interactions may include different systems that seamlessly collaborate, even if they are built using diverse technologies or platforms. This is facilitated through standardized protocols and interfaces that enable effective communication between systems. System-to-system interactions may include real-time processing: interactions that facilitate real-time data processing and decision-making. For example, an AI model may receive real-time data from a monitoring system and immediately process it to generate insights or trigger actions. System-to-system interactions may include interactions that support scalable solutions where multiple systems and AI models may be integrated to manage large volumes of data and complex tasks. This is particularly advantageous in cloud-based environments where resources may be dynamically allocated. System-to-system interactions may include systems that may function autonomously without human intervention. For example, an AI model may automatically adjust parameters in a control system based on the analysis of incoming data.

In summary, system-to-system interactions within the consensus-based network of AI models enable automated, real-time, and scalable data processing and decision-making across different systems, thereby enhancing efficiency and reducing the necessity for human intervention.

It should be understood that in FIG. 2, each of the AI models 204 may be trained with different training data. For example, one AI model 204 may be trained for a business department domain (i.e. department employing the worker); one AI model 204 may be trained for the organization domain: one AI model 204 may be trained for an industry domain; and one AI model 204 may be trained for a global domain.

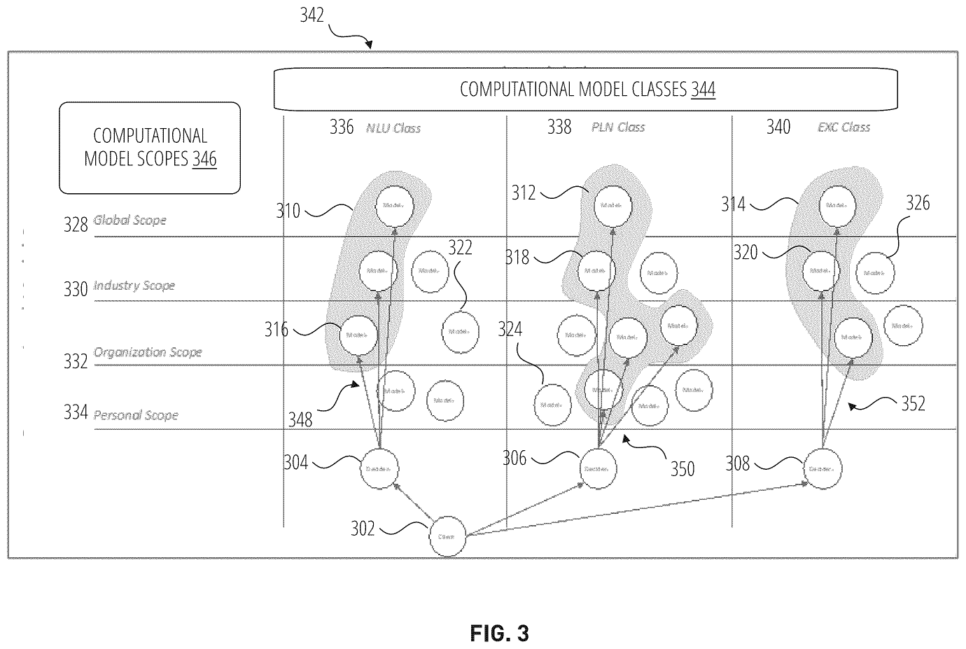

Referring to FIG. 3 there is illustrated an aspect of the subject matter in accordance with one embodiment of decider model operation within the consensus-based network 342 where AI models are grouped in computational model classes 344 and computational model scopes 346 within the consensus-based network 342 thereby providing a matrix of multi-dimensional classifications.

Computational model scopes 346 of FIG. 3 relate to the domains discussed above. In the embodiment of FIG. 3 the exemplary computational model scopes 346 are of global scope 328, industry scope 330, organization scope 332 and personal scope 334. The computational model scopes 346 are shown schematically arranged vertically relative to each other and separated by horizontal lines. One of ordinary skill in the art will appreciate that this arrangement is for illustrative purposes and may not represent the physical location of the models in the consensus-based network 342. One of ordinary skill in the art will further appreciate that while four computational model scopes 346 are shown in this diagram, the number of computational model scopes 346 may be any suitable number for the different scopes to be implemented in the consensus-based network 342.

In FIG. 3 the computational or AI models are aligned horizontally with the model scopes. The model scopes, represented by labels 328, 330, 332, and 334, are placed vertically in the diagram. Correspondingly, the AI models are positioned to the right of each model scope and are aligned horizontally with their associated model scope labels. This alignment signifies that each AI model is specifically associated with and operates within its corresponding model scope.

In FIG. 3, exemplary computational model classes 344 are shown horizontally aligned in the diagram. The exemplary computational model classes 344 comprise NLU model class 336, PLN model class 338, and EXC model class 340. These computational model classes 344 are specific implementations related to the technical requirements such as, for example, natural language process 336, planning 338 or exception handling 340. Additionally, the consensus-based network 342 includes the computational model scopes 346 that are specific instantiations of the computational model classes 344 to handle various scopes such as, for example, personal 334, organization 332, industry 330 or global 228. The framework or architecture illustrates that, in general, the implementation of computational model classes 344 is identical across all models within a class. That is, the algorithm or method of implementation is identical. However, the training or configuration data used to instantiate the computational or AI model is different and is therefore related to a scope as defined for the computational model instance. For example, training data specific to an organization 332 may be used to train an NLU Computational Model falling within the NLU model class 336. Likewise, training data specific to a user, worker or person 334 may be used to train a PLN Computational Model falling within the PLN model class 338. In the embodiment of FIG. 3, the AI models are grouped in a matrix architecture of four model scope rows (328, 330, 332, and 334) and three model class columns (336, 338 and 340.). This architecture may be supported by the orchestration engine 102 (FIG. 1). It should be understood that this simple matrix is shown for illustrative purposes and that models may be arranged in 3 dimensional groupings and may include a 4^{th} dimension related to timing.

One of ordinary skill in the art will appreciate that there may be variations in the implementations across computational model classes 344 and computational model scopes 346. However, by keeping the implementations identical within computational model classes 344, deployment and operation of the AI models is simplified within the consensus-based network 342.

One of ordinary skill in the art will appreciate that the variations used in model classes and model scopes supports various AI computational model architectures including large model and small model implementations such as, for example, baby-models for specialty focus, continuous learning on a scope or class basis, or any combination of AI model approaches.

In operation of the consensus-based network 342, a requestor may access the network 342 via client interaction hub 302 to place a request which is communicated to decider models 304, 306, 308 associated with a corresponding computational model class 344. The decider models 304, 306, and 308 send messages similar to those described for FIG. 2 along respective communication links 348, 350, and 352 to all the models in corresponding classes 336, 338, and 340. The computational or AI models that accept the request are those models shown within the corresponding shaded areas 310, 312, and 314 such as for example models 316, 318, and 320. The models shown in the unshaded areas of each class such as, for example, models 322, 324 and 326 are models that have not accepted the input request. Similar to FIG. 2 the computational models in shading are invoked by the decider model to generate a singular outcome result from each model that is returned to the corresponding decider model 304, 306, or 308 for aggregation and response to hub 200. One of ordinary skill in the art will appreciate that the consensus-based network 342 is configured to receive multiple requests from multiple client hubs 302.

It should also be understood that the while in FIG. 3 the arrows are pointing to information moving from interaction hub 302 to the decider models and then the decision focused computational models, there would also be information flow similar to FIGS. 1 and 2 of the AI decision-focused models sending acceptance information and predicted outcomes back to the decider models. Also, the decider models would in turn aggregate the outcomes and send a single trusted output response to the client hub 302. In the embodiment of FIG. 3, the client hub 302 may alternatively comprise a further hierarchical decider model that aggregates the single outcome responses from the decider models 304, 306, and 308 to generate the trusted outcome. As one of ordinary skill in the art will appreciate, the architecture of the embodiments of FIGS. 1 to 3 are scalable as AI models and decider models are added to the consensus-based network 342.

The following is an example use case for describing how the consensus-based network of the present disclosure may be applied.

For a plumber requestor persona, the requirements of sending invoices and entering work order details to the consensus-based network might involve understanding the intent of any work request related to invoicing and work orders which work requests are typically not plumbing industry specific. Therefore, computational models that are used to classify intent may be more broad-based such as, for example, a more “global” computational model.

However, determining entities associated with updating work orders (e.g. adding parts and labor) may be plumbing industry specific. In this case, work order updates would involve significant knowledge to determine entities when updates as asked for by a plumber requestor persona. It is therefore better to apply a plumbing industry specific computational model to recognize entities. Thus, the consensus-based network allows multiple model classes to be applied such that industry scopes are considered, or even sub-segment of an industry may be considered.

For each requestor work request, all models will be consulted and the model with the best fit (based on the confidence levels within the Result (r), the Score(s) or other parameters based on the context) will be selected for processing.

In the present disclosure computational model classes are concrete implementations of algorithms or methods and are utilized in understanding the orchestration of data as it is processed through the network. The implementations within each computational model class are generally identical; however, the training data, or configuration data, provided to the various implementations within a computational model class may vary. The variation in training data, or configuration data, is what supports the benefits afforded by orchestration and contextual awareness. By keeping the implementations identical within the computational model classes, the system is adaptable to achieve scalability and resiliency.

In the architecture of FIG. 3, the computational models are technically grouped such that they may be referenced during execution. These technical groupings are referred to as Computational Model Classes with each class referring to a set of algorithms, procedures and/or calculations. Stated differently, the decision-focused computational model classes are defined by algorithmic families, where each class comprises models that implement the same or similar set of algorithms, procedures, and/or calculations. The term “algorithmic families” refers to groups of algorithms that are designed to solve similar types of problems or share common characteristics. These families categorize algorithms based on their functionality, approach, or the type of problem they address. For example, the Computational Model Classes may include:
1. NLU: Natural Language Understanding models in order to support the ‘ask’ process and determine the intent of the work requests.
   a. NLUi: NLU for intent classification may be a separate Computational Model and operate independently in the NLU process.
   b. NLUe: NLU for entity recognition may be a separate Computational Model and operate independently in the NLU process.
2. NLG: Natural Language Generation in order to support responses and utterances to requestors making work requests.
3. PLN: Planning models that are part of the ‘what’ process to determine automation workflow steps.
4. TRN: Training data generation model to support generation of synthetic data for the purposes of training a network to recognize intents and entities.
5. EXC: Exception Handling to support the ‘fix’ process of the network.
6. NDG: Computational models for handling nudge requests and/or prompted nudge requests.
7. INS: Computational models for gaining insight into work requests to support analytics and reporting efforts.

Computational Model Classes are referred to by a naming convention and may also be sub-grouped. The sub-grouping is illustrated in the above listing by referring the further breakdown that is achieved in NLU processing-separation of intent classification and entity recognition. In this example, both of these models may be called upon to process a natural language input and return results depending on the method and training of the separate computational or AI models.

In the present disclosure, an orchestration algorithm may be employed for training and invoking models through a distributed computational model network to make decisions and solve problems. The algorithm makes staged and informed decisions based on context of inbound work requests. The algorithm also allows the network to scale the Computational Models by segregating computational scope and allowing for a high degree of distribution.

By providing trusted outcomes, the consensus-based network of the present disclosure may perform an intelligent automation process across cloud-based environments to enhance scalability of the intelligent automation process whereby consensus-based networks May 1) serve a large number of users, potentially in the millions, across a broad range of companies, organizations, industries and countries, 2) support rapid training and retraining of many discrete computational models, 3) enhance resilience for continuous operation, 4) enhance concurrency to operate without interruption across multiple simultaneous requests; and 5) enhance security and privacy whereby personal data is protected, along with security for proprietary models and training.

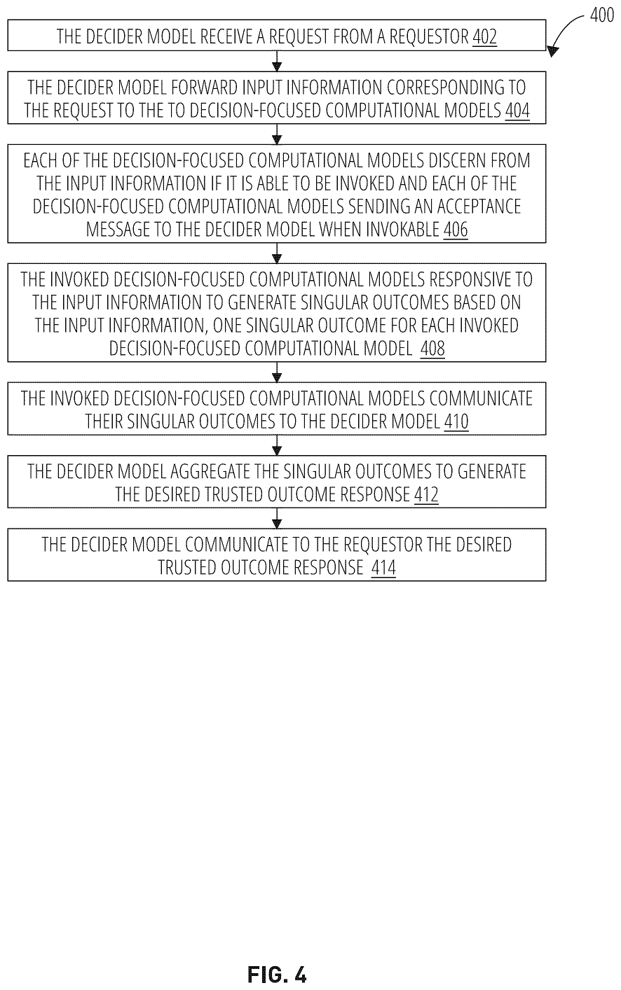

Referring to FIG. 4 there is illustrated a routine 400 performed for generating desired trusted outcomes in a consensus-based network having a plurality of decision-focused computational models, at a decider model communicatively coupled to the plurality of decision-focused computational models in accordance with one embodiment. In block 402 of routine 400 the decider model receives a request from a requestor. In block 404 the decider model forwards input information corresponding to the request to the decision-focused computational models. In block 406 each of the decision-focused computational models discerns from the input information if it is able to be invoked and each of the decision-focused computational models sending an acceptance message to the decider model when invokable. In block 408 the invoked decision-focused computational models responsive to the input information generate singular outcomes based on the input information, one singular outcome for each invoked decision-focused computational model. In block 410 the invoked decision-focused computational models communicate their singular outcomes to the decider model.

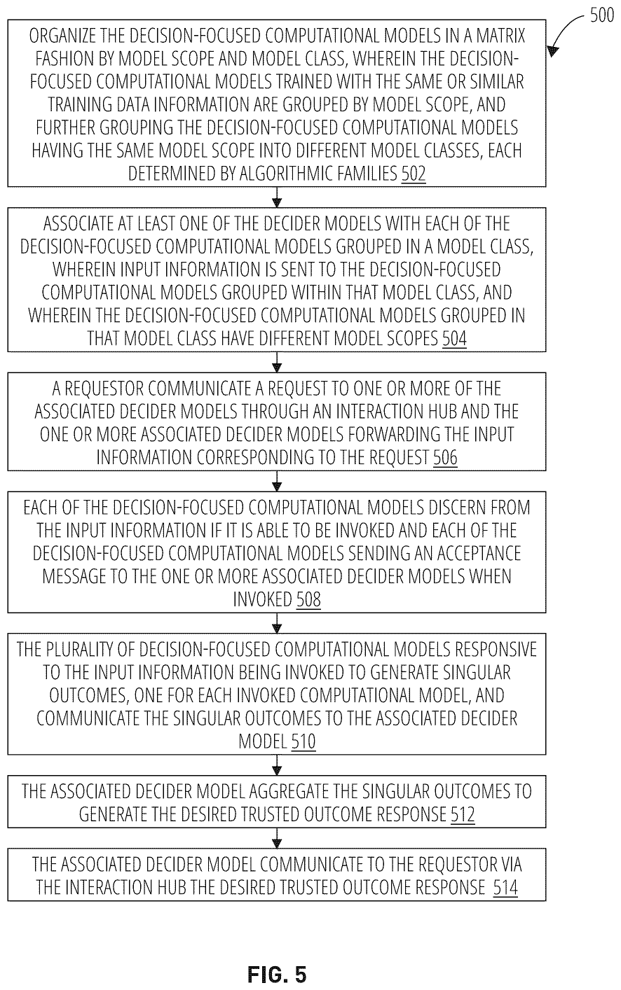

Referring to FIG. 5 there is illustrated a routine 500 performed for generating desired trusted outcomes in a consensus-based network having a plurality of decision-focused computational models, a plurality of decider models communicatively coupled to the plurality of decision-focused computational models and at least one interaction hub communicatively coupled to the decider models in accordance with one embodiment. In block 502 of routine 500 the network organizes the decision-focused computational models in a matrix fashion by model scope and model class, wherein the decision-focused computational models trained with the same or similar training data information are grouped by model scope, and further grouping the decision-focused computational models having the same model scope into different model classes, each determined by algorithmic families. In block 504, routine 500 associates at least one of the decider models with each of the decision-focused computational models grouped in a model class, wherein input information is sent to the decision-focused computational models grouped within that model class, and wherein the decision-focused computational models grouped in that model class have different model scopes. In block 506, a requestor communicates a request to one or more of the associated decider models through an interaction hub and the one or more associated decider models forwards the input information corresponding to the request. In block 508, each of the decision-focused computational models discerns from the input information if it is able to be invoked and each of the decision-focused computational models sends an acceptance message to the one or more associated decider models when invoked. In block 510, the plurality of decision-focused computational models responsive to the input information being invoked generate singular outcomes, one for each invoked computational model, and communicate the singular outcomes to the associated decider model. In block 512, the associated decider model aggregates the singular outcomes to generate the desired trusted outcome response. In block 514, the associated decider model communicates to the requestor via the interaction hub the desired trusted outcome response.

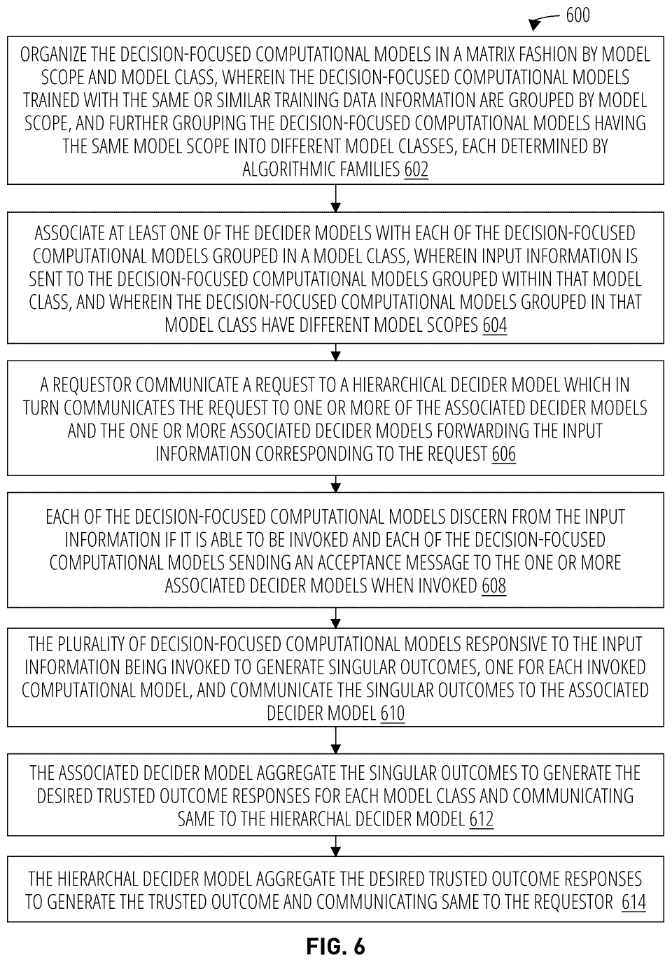

Referring to FIG. 6 there is illustrated a routine 600 for generating desired trusted outcomes in a consensus-based network having a plurality of decision-focused computational models, a plurality of decider models communicatively coupled to the plurality of decision-focused computational models and at least one hierarchal decider model communicatively coupled to the decider models in accordance with one embodiment. In block 602, routine 600 organizes the decision-focused computational models in a matrix fashion by model scope and model class, wherein the decision-focused computational models trained with the same or similar training data information are grouped by model scope, and further grouping the decision-focused computational models having the same model scope into different model classes, each determined by algorithmic families. In block 604, routine 600 associates at least one of the decider models with each of the decision-focused computational models grouped in a model class, wherein input information is sent to the decision-focused computational models grouped within that model class, and wherein the decision-focused computational models grouped in that model class have different model scopes. In block 606, a requestor communicates a request to a hierarchical decider model which in turn communicates the request to one or more of the associated decider models and the one or more associated decider models forwards the input information corresponding to the request to associated computational models. In block 608, each of the decision-focused computational models discerns from the input information if it is able to be invoked and each of the decision-focused computational models sends an acceptance message to the one or more associated decider models when invoked. In block 610, the plurality of decision-focused computational models responsive to the input information and being invoked generate singular outcomes, one for each invoked computational model, and communicate the singular outcomes to the associated decider model. In block 612, the associated decider model aggregates the singular outcomes to generate desired trusted outcome responses for each model class and communicates same to the hierarchal decider model. In block 614, the hierarchal decider model aggregates the desired trusted outcome responses to generate the trusted outcome and communicates same back to the requestor.

The consensus-based network of the disclosure may be used in various cloud-based environments to address trust challenges and enhance decision-making processes and may find application in different industry sectors such as, for example, financial services, healthcare, supply chain management, customer service, cybersecurity, legal and compliance, marketing and advertising. and/or asset valuation such as, for example, company investment analysis. A further explanation of these examples follows.

In the financial sector, the consensus-based network of the present disclosure may be used for fraud detection, risk assessment, and credit scoring. By leveraging multiple AI models to analyze transaction data, the network may provide more accurate and reliable outcomes, reducing the risk of fraudulent activities and improving the overall trust in financial decisions.

In healthcare, the consensus-based network of the present disclosure may be applied to patient diagnosis, treatment recommendations, and medical research. By aggregating outcomes from various AI models trained on different medical datasets, the network may offer more precise and trustworthy diagnostic and treatment options, enhancing patient care and outcomes.

In supply chain management, the consensus-based network of the present disclosure may optimize supply chain operations by predicting demand, managing inventory, and identifying potential disruptions. By using multiple AI models to analyze data from various sources, the network may provide more reliable forecasts and recommendations, improving efficiency and reducing costs.

In customer service, the consensus-based network of the present disclosure may be used to enhance chatbots and virtual assistants. By aggregating responses from different AI models, the network may provide more accurate and contextually relevant answers to customer queries, improving customer satisfaction and trust.

In cybersecurity, the consensus-based network of the present disclosure may be applied to threat detection and response in cybersecurity. By leveraging multiple AI models to analyze network traffic and identify potential threats, the network may provide more robust and reliable security measures, protecting sensitive data and systems.

In legal and compliance, the consensus-based network of the present disclosure may assist in contract analysis, regulatory compliance, and legal research. By aggregating outcomes from various AI models, the network may provide more accurate and trustworthy insights, helping organizations stay compliant with regulations and reduce legal risks.

In marketing and advertising, the consensus-based network of the present disclosure may optimize marketing campaigns and advertising strategies by analyzing consumer behavior and preferences. By using multiple AI models to process data from various sources, the network may provide more effective and targeted marketing recommendations, improving campaign performance and Return on Investments.

In company investment analysis the consensus-based network may aggregate and analyze data from multiple AI models to provide a comprehensive and trustworthy evaluation of a company's value. These AI models are organized into model scopes that independently process different types of data, such as, for example, a model scope for financial statements, a model scope for market trends, a model scope for competitive analysis, and a model scope for news articles. The decider model then aggregates the outcomes from these models to produce a final trusted evaluation.

These applications demonstrate the versatility and potential of the consensus-based network in enhancing trust, accuracy, and reliability across various industries and use cases in cloud-based environments.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical.

What is claimed is:

1. A method for generating desired trusted outcomes in a consensus-based network having a plurality of decision-focused computational models, and a decider model communicatively coupled to the plurality of decision-focused computational models, the method comprising:
the decider model receiving a request from a requestor;
the decider model forwarding input information corresponding to the request to the plurality of decision-focused computational models;
the plurality of decision-focused computational models responsive to the input information being invoked to generate singular outcomes based on the input information, one singular outcome for each invoked decision-focused computational model, and communicating the singular outcomes to the decider model;
the decider model aggregating the singular outcomes to generate a desired trusted outcome response; and
the decider model communicating to the desired trusted outcome response to the requestor.

2. The method for generating trusted outcomes in a consensus-based network of claim 1 further comprising each of the decision-focused computational models discerning from the input information if it is able to be invoked and each of the decision-focused computational models sending an acceptance message to the decider model when invoked.

3. The method for generating desired trusted outcomes in a consensus-based network of claim 2, wherein the forwarding input information by the decider model is to selected ones of the decision-focused computational models based on relevance and capability of each decision-focused computational model to process the input information, wherein the decider model determines suitability of each decision-focused computational model to handle the input information before forwarding the input information.

4. The method for generating trusted outcomes in a consensus-based network of claim 1 further comprising:
organizing the decision-focused computational models in a matrix fashion by model scope and model class, wherein the decision-focused computational models trained with same or similar training data information are grouped by model scope, and further grouping the decision-focused computational models having the same model scope into different model classes, each determined by algorithmic families.

5. The method for generating trusted outcomes in a consensus-based network of claim 4 further comprising the at least one decider model associated with each of the different model classes for selecting and/or merging the singular outcomes of decision-focused computational models of grouped in a same one of the different model classes to generate same class desired trusted outcomes, at least one desired trusted outcome for each same one of the different model classes; and, further comprising at least one hierarchical decider model communicatively coupled to manage invoking the at least one decider model associated with each one of the different model classes and to aggregate the generated same class desired trusted outcomes, thereby supporting hierarchical and matrixed groupings of the decision-focused computational models and the at least one decider model.

6. The method for generating trusted outcomes in a consensus-based network of claim 5 further comprising coordinating the decision-focused computational models and the at least one decider models by an orchestration engine that includes a management layer and wherein the management layer includes the at least one hierarchical decider model; and, wherein the orchestration engine is governed by a monitoring and management system providing AI governance over execution of the orchestration engine and the at least one hierarchical decider model thereby ensuring viability and integrity of execution and outcomes.

7. The method for generating trusted outcomes in a consensus-based network of claim 1 further comprising:
assigning, via the decider model, a confidence score to each one of the singular outcomes generated by each of the decision-focused computational models, wherein each of the confidence scores is indicative of the reliability and accuracy, and,
aggregating, by the decider model, the singular outcomes based on their respective confidence scores to produce the desired trusted outcome response, wherein outcomes with higher confidence scores exert a greater influence.

8. A computer implemented method according to the method for generating trusted outcomes in a consensus-based network of claim 1.

9. A consensus-based network for generating desired trusted outcomes, comprising:
a plurality of decision-focused computational models configured to process input information and generate singular outcomes, one for each computational model; and,
an orchestration engine communicatively coupled to, and configured to organize, operation of the plurality of decision-focused computational models, the orchestration engine configured to receive requests from requestors and to generate the input information related to the requests;
wherein the orchestration engine comprises at least one decider model, the at least one decider model comprising an invoke module and an aggregation module, the invoke module configured to forward the input information to the plurality of decision-focused computational models, and the aggregation module configured to receive and aggregate the singular outcomes to produce the desired trusted outcome, and, the at least one decider module configured to communicate the desired trusted outcome response to the requestor from the orchestration engine.

10. The consensus-based network for generating trusted outcomes of claim 9 wherein the plurality of decision-focused computational models is each configured to discern from the input information if it is able to be invoked so as to return the singular outcome, and when invoked sending an acceptance message to the at least one decider model.

11. The consensus-based network of claim 9, wherein the at least one decider model selectively is configured to forward the input information to selected ones of the decision-focused computational models based on relevance and capability of each decision-focused computational model to process the input information as determined by the at least one decider model.

12. The consensus-based network of claim 9 wherein the orchestration engine is configured to organize the decision-focused computational models into a multidimensional matrix based on model classes and model scopes, where each one of the model classes is defined by implementation of an algorithm families and where each one of the model scopes is defined by its training data information; and, wherein the orchestration engine is configured to organize each of the decision-focused computational models by one of the model classes and by one of the model scopes.

13. The consensus-based network of claim 12 wherein one of the at least one decider model is associated with a corresponding one of the model classes to communicate the input information to the plurality of decision-focused computational models grouped in the corresponding one model class and to receive therefrom and aggregate the singular outcomes and generate a same class desired trusted outcome; and,
wherein the orchestration engine further comprises at least one hierarchical decider model communicatively coupled to, and configured to manage, invoking the decider models associated with each of the model classes and to aggregate the generated same class desired trusted outcome received from each of the decider models.

14. The consensus-based network of claim 13 wherein the orchestration engine comprises a management layer incorporating the at least one hierarchical decider model.

15. The consensus-based network of claim 14 further comprising a monitoring and management system configured to provide AI governance over execution of the orchestration engine and the at least one hierarchical decider model thereby ensuring viability and integrity of execution and outcomes.

16. The consensus-based network of claim 9 wherein the at least one decider model is configured to:
assign a confidence score to each of the singular outcomes generated by each of the decision-focused computational models, wherein each of the confidence scores is indicative of reliability and accuracy, and, aggregate the singular outcomes based on their respective confidence scores to produce the desired trusted outcome response, wherein outcomes with higher confidence scores exert a greater influence.

17. The consensus-based network of claim 9 wherein the orchestration engine is configured to support loose coupling of the decision-focused computational models, allowing the computational models to be added or removed from the network as needed, thereby enhancing scalability and resilience.

18. The consensus-based network of claim 9 further comprising:
at least one challenger model communicatively coupled to the plurality of decision-focused computational models and the at least one decider model, wherein the challenger model is configured to validate the outcomes generated by the decision-focused computational models and/or the at least one decider model, and wherein the at least one challenger model performs validation by applying AI model methods to cross-reference checks, relevancy checks, or privacy checks to ensure trustworthiness and integrity of the outcomes within the consensus-based network.

19. A computer implemented method for generating desired trusted outcomes in a consensus-based network having a plurality of decision-focused computational models, a plurality of decider models communicatively coupled to the plurality of decision-focused computational models and at least one interaction hub communicatively coupled to the decider models, the method comprising:
organizing the decision-focused computational models in a matrix fashion by model scope and model class, wherein the decision-focused computational models trained with same or similar training data information are grouped by model scope, and further grouping the decision-focused computational models having the same model scope into different model classes, each determined by algorithmic families;
associating at least one of the decider models with each of the decision-focused computational models grouped in a model class, wherein input information is sent to the decision-focused computational models grouped within that model class, and wherein the decision-focused computational models grouped in that model class have different model scopes;
a requestor communicating a request to one or more of the associated decider models through an interaction hub and the one or more associated decider models forwarding the input information corresponding to the request;
each of the decision-focused computational models discerning from the input information if it is able to be invoked and each of the decision-focused computational models sending an acceptance message to the one or more associated decider models when invoked;
the plurality of decision-focused computational models responsive to the input information being invoked to generate singular outcomes, one for each invoked computational model, and communicating the singular outcomes to the associated decider model;
the associated decider model aggregating the singular outcomes to generate the desired trusted outcome response; and
the associated decider model communicating to the requestor via the interaction hub the desired trusted outcome response.

20. The computer implemented method of claim 19 further comprising at least one hierarchal decider model communicatively coupled between the associated decider models and the interaction hub, the method further comprising the hierarchal decider model receiving the request, invoking the associated decider models, aggregating the desired trusted outcome response from each of the associated decider models to generating the desired trusted outcomes and communicating to the requestor via the interaction hub the desired trusted outcomes.
